(19) United States
(12) Patent Application Publication
(10) Pub. No.: US 2004/0045774 A1
(43) Pub. Date: Mar. 11, 2004

(54) Wheel locking system

(76) Inventor: Nicholas D. D'Alessio, Sparta, NJ (US)

Correspondence Address: HOFFMANN & BARON, LLP, 6900 JERICHO TURNPIKE, SYOSSET, NY, 11791, US

(21) Appl. No.: 10/424,586

(22) Filed: Apr. 28, 2003

Related U.S. Application Data
(60) Provisional application No. 60/408,622, filed on Sep. 6, 2002.

(51) Int. Cl. B60T 3/00

(52) U.S. Cl. 188/4 R; 188/32

(57) ABSTRACT

A wheel locking system is provided which, in a first embodiment, generally includes first and second chocks, each chock having a pin passage extending therethrough. First and second pins are slidably disposed respectively in the pin passages of the chocks which are fixed to first and second bars that are disposed on opposing sides of the chocks. In this manner, the chocks and the bars collectively define a well in which the wheel or wheels of an aircraft may be accommodated. Because of the bars extending between the chocks, the wheel locking system cannot be readily removed from the accommodated wheel or wheels. In addition, the ability of an aircraft to roll out of the locking system is highly hindered. Locks, such as padlocks, may be provided to further enhance the security aspect of the subject invention requiring removal of the locks prior to removal of the system. Alternative embodiments are also provided, such as that which uses a flexible locking member, a single chock, and/or modular and/or combined components.

### CROSS-REFERENCE TO RELATED APPLICATIONS

This application claims priority of U.S. Provisional Application No. 60/408,622, filed Sep. 6, 2002.

### FIELD OF THE INVENTION

This invention relates to wheel locking systems, and, more particularly, to wheel locking systems for airplanes.

Locking systems for securing aircraft wheels against movement are known in the prior art. Such systems are designed for both preventing inadvertent movement, as well as, acting as security devices against theft of an aircraft. For example, U.S. Pat. No. 4,031,726, which issued on Jun. 28, 1977 to De Jager, discloses a generally U-shaped chock assembly which locks onto the brake drum of an airplane tire. In addition, U.S. Pat. No. 5,427,201, which issued Jun. 27, 1995 to Willaford, discloses a two-chock assembly which is assembled and secured to an aircraft wheel by a chain. Other chock assemblies are known in the prior art, although not specifically disclosed for use with aircraft wheels; for example: U.S. Pat. No. 3,687,238, which issued Aug. 29, 1972 to Carpenter; U.S. Pat. No. 4,711,325, which issued Dec. 8, 1987 to Mountz; U.S. Pat. No. 4,804,070, which issued Feb. 14, 1989 to Bohler; and U.S. Pat. No. 6,425,465, which issued Jul. 30, 2002 to Tallman et al.

### SUMMARY OF THE INVENTION

To overcome shortcomings of the prior art, a wheel locking system is provided which generally includes first and second chocks, each chock having at least one pin passage extending therethrough. In a first embodiment, first and second pins are slidably disposed respectively in the pin passages of the chocks which are fixed to first and second bars that are disposed on opposing sides of the chocks. In this manner, the chocks and the bars collectively define a well in which the wheel or wheels of an aircraft may be accommodated. Because of the bars extending between the chocks, the wheel locking system cannot be readily removed from the accommodated wheel or wheels. In addition, the ability of an aircraft to roll out of the locking system is highly hindered. Locks, such as padlocks, may be provided to further enhance the security aspect of the subject invention requiring removal of the locks prior to removal of the system.

As will be readily recognized by those skilled in the art, more than one pin passage may be formed in each chock, thereby allowing for positioning the pins and bars in different arrangements.

In a second embodiment of the subject invention, an elongated, flexible locking member, such as a steel cable, may be threaded through one or more of the pin passages of each chock to provide a holding force therebetween. The ends of the locking member can be fastened, or even locked, to retain the holding force.

In a further, third embodiment of the subject invention, only one chock is used having at least one pin passage extending therethrough. This embodiment is utilizable with airplane wheels having an open passage extending through its wheel axle. A pin is passed through one of the pin passages of the chock, and a second pin is passed through the wheel's open passage. The pins are fixed together as in the first embodiment. As a further variation, an elongated flexible locking member (as used with the second embodiment) may be used in the configuration of the third embodiment, in lieu of the pins and bars.

As a variation of any of the aforementioned embodiments, ribs for enhanced traction and/or a carrying handle may be provided.

In yet further embodiments, the components of the system may be formed modularly or combined.

These and other features of the invention will be better understood through a study of the following detailed description and accompanying drawings.

### BRIEF DESCRIPTION OF THE DRAWING

FIG. 1 is a perspective view of a first embodiment of a wheel locking system formed in accordance with the subject invention.

FIG. 2 is a top plan view of the wheel locking system of FIG. 1.

FIG. 3 is a perspective view of a bar used in conjunction with the subject invention.

FIG. 4 is a top plan view of a pin used in conjunction with the subject invention.

FIG. 5(a) is an elevational view of a chock having more than one pin passage.

FIG. 5(b) is a top plan view of the top surface of a chock.

FIG. 6 is an elevational view of a second embodiment of the wheel locking system.

FIG. 7 is an elevational view of a third embodiment of the wheel locking system.

FIG. 8(a) is an elevational view of a chock having ribs and a carrying handle.

FIG. 8(b) is a partial top plan view of the chock of FIG. 8(a).

FIG. 9 is an exploded view of a wheel locking system having modular and combined components.

FIG. 10 is a partial top plan view of an alternative embodiment wherein a locking member is fixed in proximity to a side of a chock.

### DETAILED DESCRIPTION OF THE INVENTION

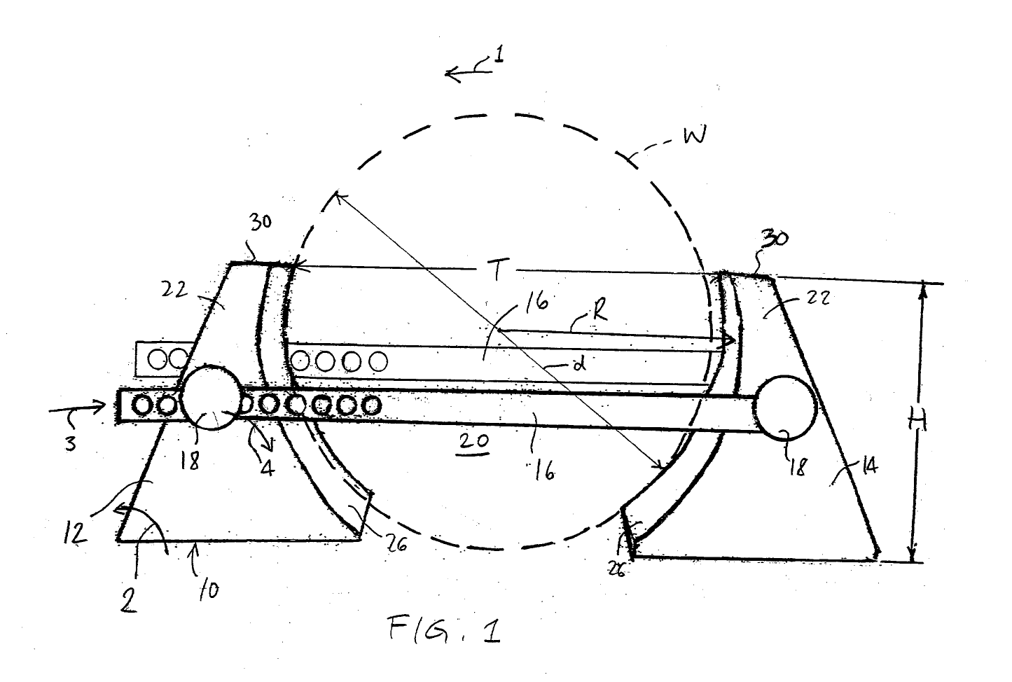

With reference to FIGS. 1-4, a first embodiment of a wheel locking system is shown and generally designated with the reference numeral 10. The system 10 generally includes fore and aft chocks 12, 14, at least two bars 16, and at least two pins 18. The chocks 12, 14 and the bars 16 collectively define a well 20 for accommodating a wheel or wheels W, as represented in dashed lines. Advantageously, with the bars 16 being located on both sides of the wheel or wheels W, the system 10 cannot be readily removed from about the wheel or wheels W. As will be recognized by those skilled in the art, the system 10 can be utilized in various wheel-chocking applications, but is particularly well-suited for use with airplane wheel(s).

The fore and aft chocks 12, 14 are preferably identically formed, with each chock 12, 14 having first and second side surfaces 22, 24, a ramped surface 26 extending between the first and second side surfaces 22, 24, and a base surface 28. The ramped surfaces 26 may each be formed arcuately, such as about a single radius R, as shown in FIG. 1, for example to match a partial diameter of a common aircraft wheel, or, alternatively, may be a generally flat angled surface, multiple flat surfaces, or a combination of arcuate and flat surfaces. The ramped surfaces 26 should be formed such that the well 20 may accommodate a range of wheel diameters.

The chocks 12, 14 preferably have a generally triangular shape to resist movement of the wheel or wheels W. It is preferred that each of the ramped surfaces 26 curves inwardly at its upper end 30. It is also preferred that the upper ends 30 be spaced a height H from the respective base surfaces 28 and be spaced apart a distance T which is less than the diameter D of the wheel or wheels W to be accommodated. With the height H being preferably greater than half the diameter D (i.e., greater than the radius of the wheel or wheels W), the upper ends 30 provide a necked opening against unhindered upward movement of the wheel or wheels W out of the well 20.

As will be appreciated by those skilled in the art, various geometric configurations of the chocks 12, 14 may be used, beyond that which is shown in the figures. The chocks 12, 14 may be unitarily formed (such as by molding), or assembled from multiple parts. In addition, the chocks 12, 14 may be made from various materials, including, but not limited to, wood, rubber, metal and plastic.

Each of the chocks 12, 14 also includes a pin passage 32 which extends between and through the first and second side surfaces 22, 24 of the chocks 12, 14, as best shown in FIG. 2. Depending on the constituent material of the chocks 12, 14, bushings (not shown) may be provided to at least partially line the pin passages 32.

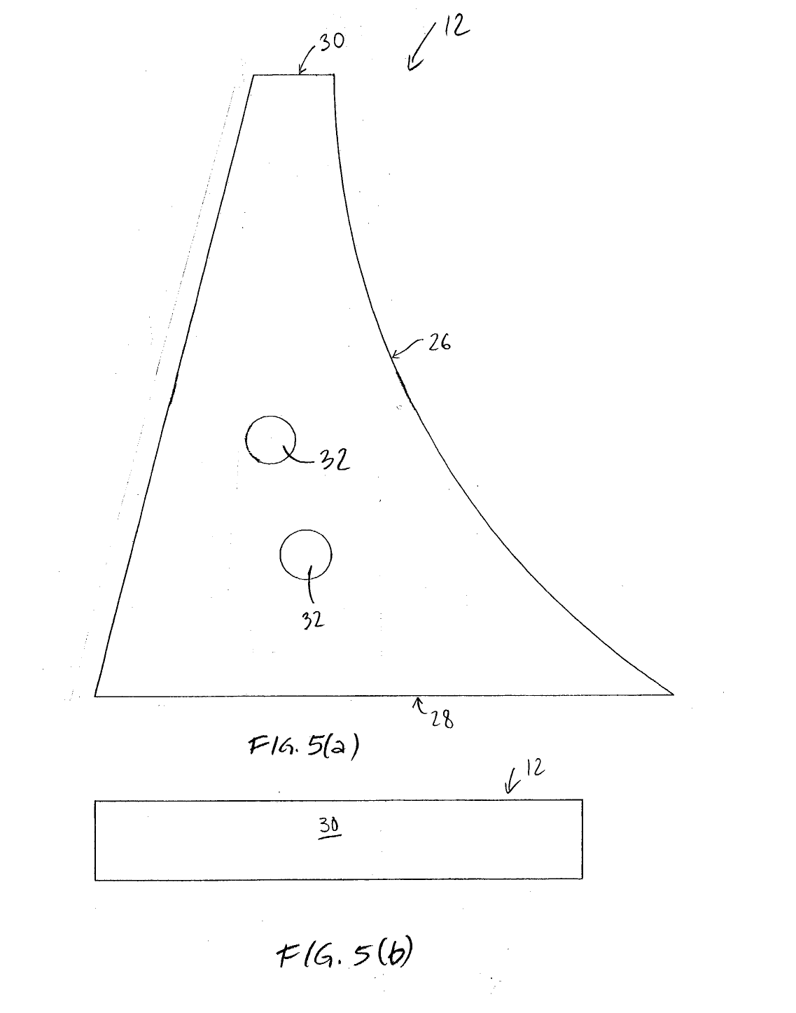

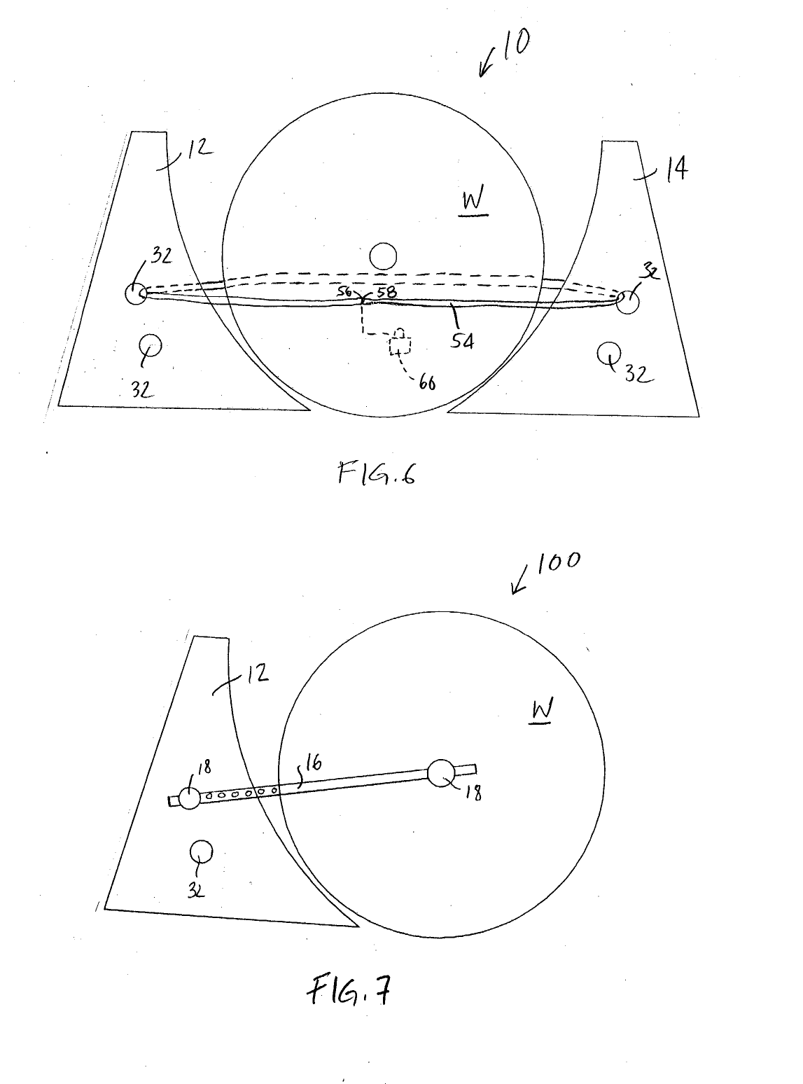

With reference to FIG. 4, each of the pins 18 is preferably formed from metal with a shaft 34 and an enlarged portion 36 located at one end thereof. A locking hole 38 is defined through the shaft 34 in proximity to end 40 located opposite the enlarged portion 36. The shaft 34 is formed to pass through one of the pin passages 32.

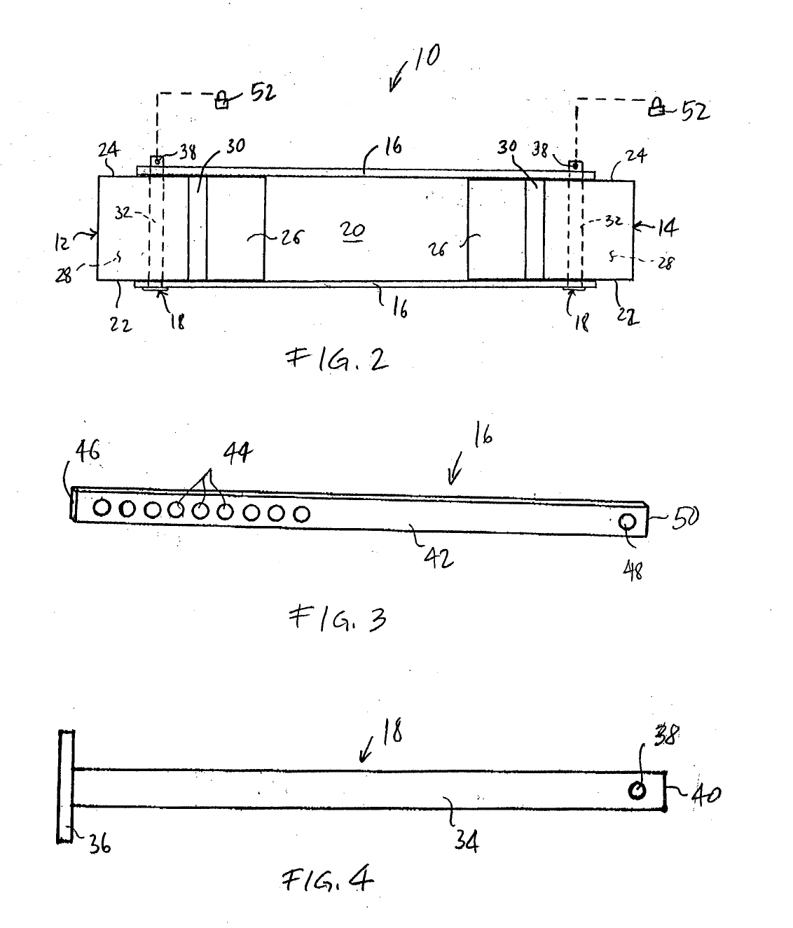

With reference to FIG. 3, each of the bars 16 is formed with a body 42 having a plurality of adjustment holes 44 formed in series extending from one end 46 and a fixed hole 48 located in proximity to an opposite end 50. The number, size and placement of the adjustment holes 44 can be varied to allow the system 10 to function with a range of wheel diameters. As is readily apparent, the distance T between the upper ends 30 of the chocks 12, 14 can be varied by using various adjustment holes 44. The adjustment holes 44 and the fixed holes 48 are each sized and configured to allow for passage therethrough of the shaft 34 of one of the pins 18, but not the enlarged portion 36 thereof. It is preferred that both the bars 16 be formed of metal.

In assembling the system 10, the chocks 12, 14 are positioned about the wheel or wheels W in fore and aft positions, respectively. One of the pins 18 is passed through the fixed holes 48 of the bars 16, with the bars 16 being located on opposite sides of the chocks 12, 14. One of the adjustment holes 44 of each of the bars 16 is then aligned with the pin passage 18 of the other chock 12, 14. Once aligned, one of the pins 18 is passed therethrough. FIG. 2 shows the assembled system 10. It is preferred that the pins 18 be formed of sufficient length to protrude and to at least partially expose the locking holes 38. Any technique known to those skilled in the art may be used to maintain the system 10 intact, including, but not limited to, placing a fastener, such as a cotter pin, in one or both of the locking holes 38. For a higher form of security, locks 52, such as padlocks, may be locked onto one or both of the locking holes 38. To facilitate installation and removal of the locks 52, it is preferred that a common key be used for the locks 52.

The width of the chocks 12, 14 may be adjusted to accommodate a typical width of the wheel or wheels W (e.g., to accommodate a single wheel or a multi-wheel landing gear). In addition, the bars 16 and or the pins 18 may be formed as flexible members, such as from chains or cable, or as folding members. As will be appreciated by those skilled in the art, any technique of fixing the bars 16 and the pins 18 together may be utilized, such as with threaded connections.

For exemplary purposes, for a wheel diameter of 18 inches, the chocks 12, 14 may be formed with the radius R of 9 inches and the height H of 12-13.625 inches.

Each of the base surfaces 28 is preferably formed at least partially flat to define stable resting surfaces for the chocks 12, 14. It is preferred that the pin passages 32 be formed at locations spaced from the resting surfaces defined by the base surfaces 28. Accordingly, the bars 16 and the pins 18 can collectively generate counteracting moments defined against any movement of the wheel or wheels W. For example, with reference to FIG. 1, with movement of the wheel or wheels W in the direction 1, a moment force will be applied against the chock 12 as represented by the arrow 2. Because the pin 18 is located as such, a counteracting force represented by arrow 3 will be generated against the movement, resulting in a counteracting moment represented by arrow 4. If the pin 18 were to be secured to the chock 12 at or in proximity to the base surface 28 of the chock 12, the counteracting moment 4 would be negligible or nonexistent. With the spacing as discussed herein, a moment arm exists between the base surface 28 of the chock 12 and the pin 18, allowing for a more meaningful counteracting moment 4 to be generated.

Other variations to the system 10 are possible. For example, more than two of the bars 16 and/or the pins 18 may be used with the subject invention, as will be recognized by those skilled in the art. In addition, as shown in FIG. 5(a), the chocks 12, 14 may include more than one of the pin passages 32 to allow for different positioning of the bars 16 and the pins 18.

With reference to FIG. 6, in a second embodiment of the subject invention, an elongated flexible locking member 54, such as a steel cable or a chain, may be threaded through one or more of the pin passages 32 of each of the chocks 12, 14 to provide a holding force therebetween. The flexible locking member 54 traverses a continuous path through both of the chocks 12, 14 and along the sides 22, 24 thereof. The flexible locking member 54 is preferably formed with sufficient length to define a loop where the ends 56 and 58 of the locking member 54 may be fastened, or even locked by a lock 60, to retain the holding force. Preferably, the locking member 54 is disposed about the wheel or wheels W and not fixed thereto.

In a third embodiment of the subject invention, a system 100 is provided using one of the chocks 12, 14. This embodiment is utilizable with wheel or wheels W having an open passage extending through its wheel axle(s). One of the pins 18 is passed through the open passage and fixed to one of the pins 18 extending through the adjacent chock 12. The pins 18 are fixed together using the bars 16, as described above with respect to the first embodiment. As a further variation, an elongated flexible locking member (as used with the second embodiment) may be used in the configuration of the third embodiment, in lieu of the pins 18 and the bars 16.

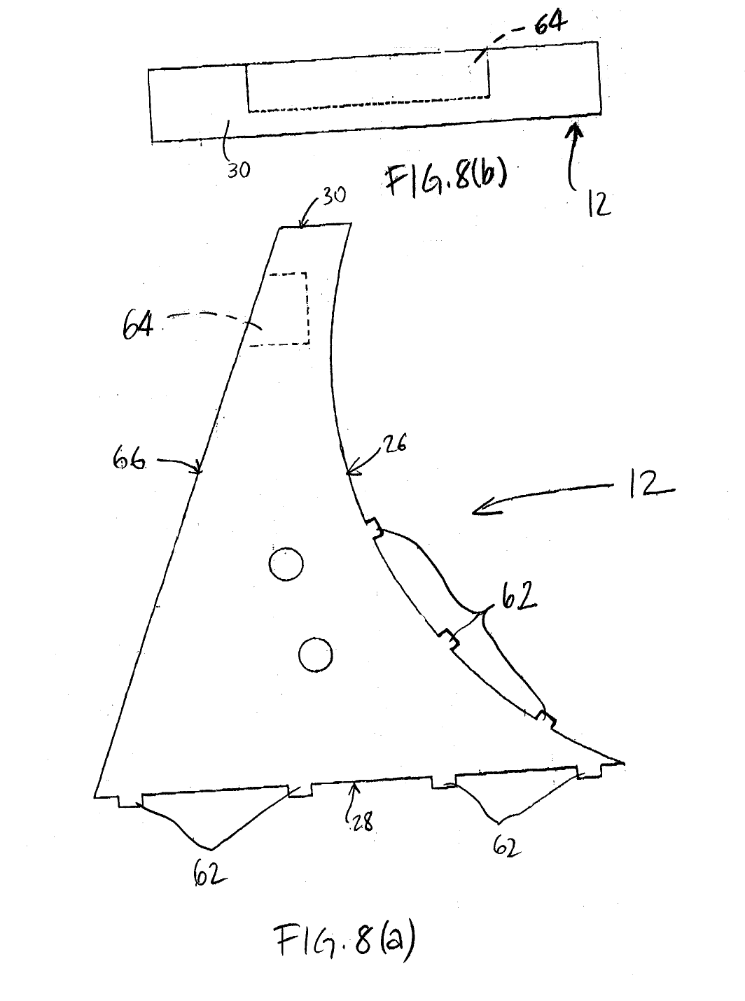

With reference to FIGS. 8(a) and 8(b), the chocks 12, 14 of any of the above-described embodiments may be provided with ribs 62 and/or a carrying handle 64. The ribs 62 are preferably formed integrally with the chocks 12, 14 such as being embossed thereon. The ribs 62 may protrude from the base surfaces 28 to enhance traction of the chocks 12, 14 against the ground and/or from the ramped surfaces 26 to enhance traction of the chocks 12, 14 against a wheel or wheels which are to be accommodated. The ribs 62 may be cross-sectionally formed in various configurations, but preferably are rectangular. Preferably, the ribs 62 are generally straight, spaced-apart and parallel to the longitudinal axis of the chocks 12, 14. Any number and arrangement of the ribs 62 may be provided as will be appreciated by those skilled in the art.

The carrying handle 64 is a cut-out preferably recessed into an aft surface 66 of one or both of the chocks 12, 14 and preferably in proximity to the upper end 30. The cut-out may extend all the way through the respective chock 12, 14. The carrying handle 64 should have sufficient width and depth to allow a person to comfortably place a hand against the aft surface 66 and insert their finger tips into the carrying handle 64 to allow for manual transport thereof.

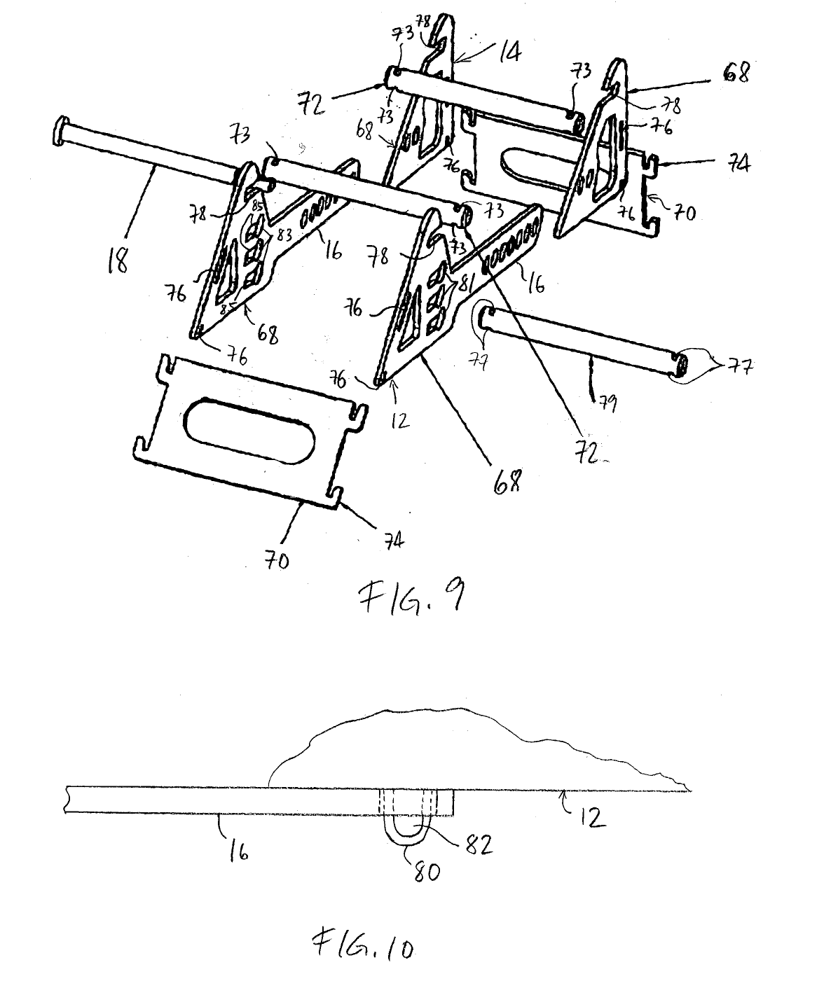

As will be appreciated by those skilled in the art, components of any of the above-described embodiments may be modularly formed or combined. For example, with reference to FIG. 9, the chocks 12, 14 may be formed from two or more components, such as side walls 68, rear wall 70, and one or more connecting rods 72. The components are preferably formed to not be disassembled once assembled about a wheel or wheels which are to be accommodated. By way of non-limiting example, the rear wall 70 may have U-shaped tabs 74 formed to slide into channels 76 in the side walls 68. With the rear wall 70/side walls 68 assembly on the ground, the side walls 68 have portions nested in the tabs 74 with such nesting preventing transverse removal of the side wall(s) 68 from the rear wall 70. In addition, the connecting rods 72 may have notches 73 to be received in locking channels 78. Again, the nesting of the connecting rods 72 in the locking channels 78 prevents transverse removal of the side wall(s) 68 from the remainder of the assembly. With the entire assembly being about the accommodated wheel or wheels, the connecting rods 72 are preferably not removable, since the locking channels 78 preferably face inwardly.

In addition, one or more of the bars 16 may be formed unitarily with the chocks 12, 14. For example, with reference to FIG. 9, the bars 16 may be formed unitarily with the side walls 68 of one of the chocks 12, 14. With this arrangement, advantageously, only one of the pins 18 need be provided to extend through the free ends of the bars 16 and through the other of the chocks 12, 14. To ensure sufficient transverse rigidity is provided to the chock 12, 14 which does not utilize the pin 18, one or more support bars 79 may be used having notches 77 similar to the connecting rods 72. The side walls 68 of the chock 12, 14 not utilizing the pin 18 may be formed with one or more support bar apertures 81 for receiving the support bar 79. As shown in FIG. 9, the support bar apertures 81 each may have an enlarged portion 83, through which the support bar 79 may pass, and an adjacent smaller receiving portion 85, in which the notches 77 may nest.

In addition, the pins 18 need not be used with the bars 16 being directly fixed to the chocks 12, 14. For example, as shown in FIG. 10, a protrusion 80 may extend from one or more the chocks 12, 14 onto which the locking holes 38 bar(s) 16 are received. The protrusion 80 may include a locking aperture 82 to receive the lock 52.

Various changes and modifications can be made to the present invention. It is intended that all such changes and modifications come within the scope of the invention as set forth in the following claims.

What is claimed is:

1. A wheel locking system comprising:
first and second chocks, each said chock having a first side surface, a second side surface, a ramped surface extending between said first and second side surfaces, and at least one pin passage extending between and through said first and second side surfaces;
first and second pins slidably disposed respectively in one of said pin passages of said first and second chocks;
a first locking member fixed to said first and second pins, said first locking member disposed adjacent to said first surfaces of said first and second chocks; and
a second locking member fixed to said first and second pins, said second locking member disposed adjacent to said second surfaces of said first and second chocks.

2. A system as in claim 1, wherein said ramped surfaces are arcuate.

3. A system as in claim 2, wherein said ramped surfaces curve inwardly.

4. A system as in claim 1, wherein said first and second locking members are each a bar.

5. A system as in claim 4, wherein said first and second locking members are each formed with at least one fixed hole extending therethrough, said first and second locking members being fixed to said first pin with said first pin passing at least partially through said fixed holes.

6. A system as in claim 5, wherein said first pin includes an enlarged portion, said enlarged portion being formed to not pass through said fixed hole of at least said first locking member.

7. A system as in claim 5, wherein each of said first and second locking members is formed with a plurality of serially-arranged adjustment holes.

8. A system as in claim 7, wherein said first and second locking members being fixed to said second pin with said second pin passing at least partially through one of said adjustment holes in each of said first and second locking members.

9. A system as in claim 8, wherein said second pin includes an enlarged portion, said enlarged portion being formed to not pass through said adjustment holes of at least said first or second locking members.

10. A system as in claim 1, wherein each of said first and second locking members is formed with a plurality of serially-arranged adjustment holes.

11. A system as in claim 10, wherein said first and second locking members being fixed to said first pin with said first pin passing at least partially through one of said adjustment holes in each of said first and second locking members.

12. A system as in claim 1, wherein said first pin is formed with a locking hole extending therethrough, said locking hole being at least partially exposed with said first pin being disposed in said first chock.

13. A system as in claim 12, further comprising at least one lock removably mountable to said first pin so as to at least partially extend into said locking hole.

14. A system as in claim 1, wherein at least one rib protrudes from said first chock.

15. A system as in claim 1, wherein a cut-out is formed in said first chock to define a carrying handle therefor.

16. A wheel locking system comprising:
first and second chocks, each said chock having a first side surface, a second side surface, a ramped surface extending between said first and second side surfaces, and at least one passage extending between and through said first and second side surfaces; and,
a flexible locking member traversing a continuous path extending through at least one said passage of said first chock, between said first and second chocks along said first sides of said first and second chocks, through at least one said passage of said second chock, and between said first and second chocks along said second sides.

17. A system as in claim 1, wherein said flexible locking member is selected from the group consisting of a cable and a chain.

18. A wheel locking system comprising:
a chock having a first side surface, a second side surface, a ramped surface extending between said first and second side surfaces, and at least one pin passage extending between and through said first and second side surfaces;
a first pin slidably disposed in one of said pin passages;
a second pin formed to be disposed through a wheel assembly;
a first locking member fixed to said first and second pins, said first locking member disposed adjacent to said first surface of said chock; and
a second locking member fixed to said first and second pins, said second locking member disposed adjacent to said second surface of said chock.

19. A wheel locking system comprising:
a chock having a first side surface, a second side surface, a ramped surface extending between said first and second side surfaces, and at least one pin passage extending between and through said first and second side surfaces; and
a flexible locking member traversing a continuous path extending through at least one of said passages of said chock, between said chock and a wheel assembly along said first side of said chock, through said wheel assembly, and between said chock and said wheel assembly along said second side of said chock.

20. A system as in claim 18, wherein said flexible locking member is selected from the group consisting of a cable and a chain.

21. A wheel locking system comprising:
first and second chocks, each said chock having a first side surface and a second side surface;
first and second locking members being unitarily formed with said first chock, said locking members extending respectively from said first and second side surfaces; and,
a first pin extending through said second chock, said first and second locking members being fixed to said pin.

22. A method for preparing a wheel locking system for locking a wheel or wheels comprising:
disposing first and second chocks in a spaced-apart relation about the wheel or wheels, each said chock having a first side surface and a second side surface; and,
fixing a first locking member relative to said first chock in proximity to said first side surface of said first chock, said first locking member extending between said first and second chocks and across the wheel or wheels.

23. A method as in claim 22, wherein said fixing is directly fixing to said first chock.

24. A method as in claim 22, wherein said fixing is indirectly fixing to said first chock.

25. A method as in claim 24, further comprising disposing a pin through said first chock, and fixing said locking member to said pin to obtain said indirect fixing.
